(19) United States
(12) Patent Application Publication
(10) Pub. No.: US 2017/0274726 A1
(43) Pub. Date: Sep. 28, 2017

(54) AIR CONDITIONING APPARATUS FOR A VEHICLE

(71) Applicant: KEIHIN CORPORATION, Tokyo (JP)

(72) Inventor: Tsunetoshi Kitamura, Utsunomiya-shi (JP)

(73) Assignee: KEIHIN CORPORATION, Tokyo (JP)

(21) Appl. No.: 15/451,699

(22) Filed: Mar. 7, 2017

(30) Foreign Application Priority Data
Mar. 24, 2016 (JP) 2016-059768

(51) Int. Cl. B60H 1/00

(52) U.S. Cl. CPC B60H 1/00064; B60H 1/00678; B60H 1/00842; B60H 2001/00092

(57) ABSTRACT

In the air conditioning system for a vehicle, when the mode is switched from a bi-level mode in which cold air is blown to a vicinity of a face of a passenger while warm air is blown to a vicinity of a foot to a vent mode in which only the cold air is blown to the vicinity of the face, the time at which the heating damper is started to be closed is delayed relative to the time at which the vent damper is started to be further opened, and the above heat damper is caused to be in a fully closed state in a state where the above vent damper is sufficiently opened. As a result, the heat damper can be operated after the pressure within the air conditioning case is reduced. Therefore, the driving torque of the actuator for driving the heat damper can be reduced.

### BACKGROUND OF THE INVENTION

Field of the Invention

The present invention relates to an air conditioning apparatus for a vehicle which is mounted on a vehicle and which blows air, the temperature of which has been adjusted by a heat exchanger, into a compartment of the vehicle to perform adjustment to the temperature inside the compartment.

Description of the Related Art

Conventionally, an air conditioning apparatus for a vehicle which is mounted on a vehicle introduces air into the air conditioning case through an internal and external air switching apparatus with use of a blower, and for example blows air from a plurality of air-outlets provided on the above air conditioning case into a compartment of the vehicle, after mixing cold air cooled by a evaporator which is a cool unit with warm air heated by a heater core which is a heat unit at a desired mixing ratio by driving a air mix damper. See, for example, Patent Literature 1 (cited below).

In such an air conditioning apparatus for a vehicle, when switching a mode of blowing air into the compartment, the switching is performed by a plurality of door operations which cause opening/closing of (a) a vent air-outlet connected via a duct to a vicinity of a face of a passenger inside the compartment and/or (b) a foot air-outlet connected to a vicinity of a foot of the passenger.

### Background Art Literature

Patent Literature 1: Japanese Patent Application Laid-Open No. 2002-103951.

### SUMMARY OF THE INVENTION

### Problems to be Solved by the Invention

In the above-described air conditioning apparatus for a vehicle, when the air blowing mode is switched, the opening and/or closing operations of two doors are normally started at the same time. For example, when the mode is switched from a bi-level mode in which air is simultaneously blown to the vicinity of the passenger's face and foot to a vent mode in which air is blown to only the vicinity of the passenger's face, the vent door is caused to operate in the direction of opening and the heat door is caused to operate in the direction of closing. However, in a recent air conditioning apparatus for a vehicle, particularly with the advancements of small size and large amount of air, if the heat door is closed before the vent door is fully opened, there is a problem that the internal pressure within the air conditioning case rises, and the driving torque of the driving source which makes the above heat door operate is thereby caused to be increased.

In order to solve this problem, the rise of the internal pressure within the air conditioning case is suppressed by equalization of the operation costs of the individual doors when the air blowing mode is switched. However, since the layouts of the doors and/or the links for driving the doors are limited, the degree of freedom of the design is decreased. In addition, in the case where a plurality of doors are disposed adjacent to each other, in order to prevent the front ends of the doors from approaching each other during operation, as for the rotation of the driving source, it is necessary to change the rotation of the door in the middle of the mode change. Therefore, there is a problem that the construction of the link is led to be further complicated.

The present invention has been made in view of the above-described problems. One object of the preferred embodiments of the present invention is to provide an air conditioning apparatus for a vehicle which is capable of reducing, with a simple construction, the internal pressure within the air conditioning case when causing the doors to perform the opening/closing operations, thereby realizing the reduction of the driving torque.

### Solutions for Solving Problems

In order to achieve, e.g., the above object, the preferred embodiments of the present invention include an air conditioning apparatus for a vehicle includes a blower; an air conditioning case that an air flow path through which air from the blower flows are formed therein; a first opening and a second opening that communicate an outer side and an inner side of the air conditioning case at downstream of the air flow path; a first door that opens/closes the first opening; a second door that opens/closes the second opening; and a driving source that drives at least either one of the first door and the second door, and comprises a first mode in which the first door causes the first opening to be opened and the second door causes the second opening to be fully closed or to be opened with a middle opening degree; and a second mode in which the first door causes the first opening to be closed more than in the first mode and the second door causes the second opening to be opened more than in the first mode, wherein when a transition is made from the first mode to the second mode, the second door is caused to start opening operation before the first door performs closing operation.

According to the preferred embodiments of the present invention, in an air conditioning case of an air conditioning apparatus for a vehicle, a first door that opens/closes a first opening and a second door that opens/closes a second opening are included, when a transition is made from a first mode in which the first opening is opened and the second door causes the second opening to be fully closed or to be opened with a middle opening degree to a second mode in which the first door causes the first opening to be closed more than in the first mode and the second door causes the second opening to be opened more than in the first mode, the second door is caused to start opening operation before the first door performs closing operation.

Thus, the rise of the pressure within the air conditioning case can be suppressed by opening the second opening, and the resistance to the operation of the first door can be suppressed by causing the first door to start closing operation with the rise of the pressure being suppressed. Thereby, operations are performed smoothly. As a result, when the mode is switched from the first mode to the second mode, the driving load for driving the first door is reduced by reducing the internal pressure within the air conditioning case. Thereby, the driving torque of the driving source can be reduced.

In addition, the second door is a plate door which is provided with a rotating shaft on a shield plate. When a transition is made from the first mode to the second mode, in the case where the shield plate is moved towards the direction opposite to the blowing direction, the plate door which is provided with a rotating shaft on a shield plate is easy to be affected by the internal pressure within the air conditioner case. However, by causing the second opening to be opened firstly so as to reduce the internal pressure as described above, the second door can be smoothly operated.

Further, by operating the first and second doors with the same driving source, the driving torque is increased as compared with the case where drive is performed by respective separated actuators. Thus, the reduction of the internal pressure within the air conditioner case by the above manner can obtain better effects.

In addition, the first opening is a heat opening which is connected to a duct for guiding air to the vicinity of the foot of a passenger, and the second opening is a vent opening which is connected to a duct for guiding air to the vicinity of the face of the passenger. The first mode is a bi-level mode in which the opening degree of each of the first and second doors is caused to be a middle opening degree, and the second mode is a vent mode in which the first door causes the heat opening to be blocked and the second door causes the vent opening to be in a fully opened state.

### The Effects of the Preferred Embodiments of the Invention

According to the preferred embodiments of the present invention, the following effects can be obtained.

That is, in an air conditioning case of an air conditioning apparatus for a vehicle, a first door that opens/closes a first opening and a second door that opens/closes a second opening are included, when a transition is made from a first mode in which the first opening is opened and the second door causes the second opening to be fully closed or to be opened with a middle opening degree to a second mode in which the first door causes the first opening to be closed more than in the first mode and the second door causes the second opening to be opened more than in the first mode, the second door is caused to start opening operation before the first door performs closing operation. Thus, the rise of the pressure (internal pressure) within the air conditioning case can be suppressed by opening the second opening, and the resistance to the operation of the first door can be suppressed by causing the first door to start closing operation with the rise of the pressure being suppressed. Thereby, operations are performed smoothly. As a result, when the mode is switched from the first mode to the second mode, the driving load for driving the first door is reduced by reducing the internal pressure within the air conditioning case. Thereby, the driving torque of the driving source can be reduced.

### BRIEF DESCRIPTION OF THE DRAWINGS

FIG. 1 is an overall cross-sectional view showing a bi-level mode state of an air conditioning apparatus for a vehicle according to an embodiment of the present invention.

FIG. 2 is an overall cross-sectional view showing a state in the middle of switching from the bi-level mode to a vent mode in the air conditioning apparatus for a vehicle of FIG. 1.

FIG. 3 is a characteristic graph showing a relationship between the opening degrees of a vent damper and a heat damper and the driving amount of a actuator when switching from the bi-level mode to the vent mode.

FIG. 4 is an overall cross-sectional view showing a state of having switched to the vent mode in the air conditioning apparatus for a vehicle of FIG. 1.

### DESCRIPTION OF THE PREFERRED EMBODIMENTS

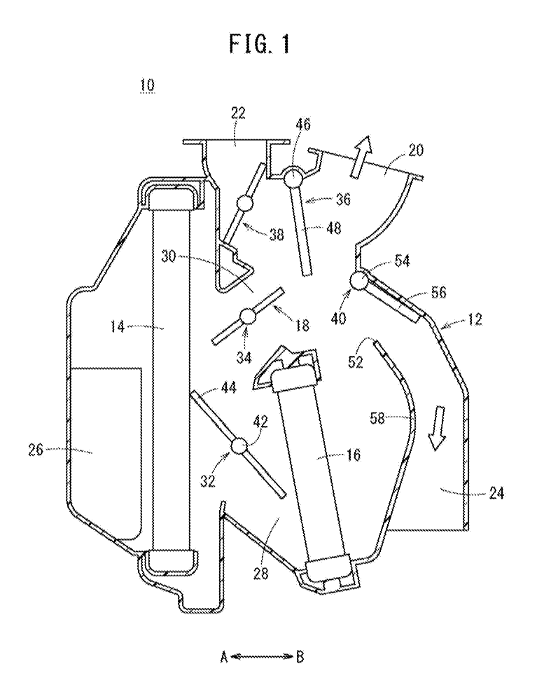

With respect to an air conditioning apparatus for a vehicle according to the present invention, the preferred embodiments will be exemplified and described below in detail with reference to the drawings. In FIG. 1, reference numeral 10 shows the air conditioning apparatus for a vehicle according to a preferred embodiment of the present invention. It should be noted that, with respect to the air conditioning apparatus for a vehicle 10, the description will be made with (a) the left side (the direction of the arrow A) shown in FIG. 1 as being referred to as the front side of a vehicle and (b) the right side (the direction of arrow B) as being referred to as the rear side of the vehicle.

As shown in FIG. 1, the air conditioning apparatus for a vehicle 10 includes an air conditioning case 12 which constitutes each of communicating paths of air, an evaporator 14 which is provided inside the above air conditioning case 12 and cools the above air, a heating core 16 which heats the air, and a damper mechanism 18 which is used for switching the flow direction of the air flowing through each of the above communicating paths.

The air conditioning case 12 is formed, for example, in a case-like shape by resin material. and the air conditioning case 12 has a vent air-outlet (a second opening, a vent opening) 20, which communicates with each communicating path and blows air to the vicinity of a passenger's face, and a defrost air-outlet 22, which blows air to the front window of the vehicle, opened at the upper side thereof. In addition, a heat communicating path 24 for blowing air to the vicinity of the foot of the passenger in the compartment of the vehicle is formed in the air conditioning case 12 on the vehicle rear side.

On the other hand, in the inside of the air conditioning case 12, the evaporator 14 is disposed vertically in a vertical direction at a position on the vehicle front side (the direction of the arrow A). A supply communicating path 26 communicating with a blower unit (not shown) is formed on the vehicle front side (the direction of the arrow A) as the upstream side of the evaporator 14. As for the evaporator 14, a refrigerant is circulated in a tube (not shown), and heat exchange is performed with the above refrigerant through the air between the tubes so as to supply cold air to the downstream side.

In addition, at a lower position, as the downstream side of the evaporator 14, in the air conditioning case 12, a warm air communicating path 28 is formed and a heating core 16 is provided, and a cold air communicating path 30 bypassing the heating core 16 is provided above the above warm air communicating path 28. The heating core 16 is provided to circulate hot water from an internal combustion engine (not shown) in the inside thereof and to supply warm air to the downstream side by performing heat exchange with the air passed.

The damper mechanism 18 includes a first air mix damper 32 disposed in the warm air communicating path 28 between the evaporator 14 and the heating core 16, a second air mix damper 34 disposed in the cold air communicating path 30 above the first air mix damper 32, a vent damper (a second door) 36 for switching the opening/closing states of the vent air-outlet 20 and the defrost air-outlet 22, a defrost damper 38 for opening/closing the above defrost air-outlet 22, and a heat damper (a first door) 40 for switching the communicating states of the heat communicating path 24.

The first air mix damper 32 has a butterfly-shaped structure in which a group of door portions 44 extend in a direction away from each other with a rotating shaft 42 as a center. The first air mix damper 32 is rotated by a driving effect of an actuator (not shown) with the rotating shaft 42 as a fulcrum so as to adjust the blowing amount (blowing ratio) of air blown to the side of the heating core 16 out of the cold air passed through the evaporator 14.

As with the first air mix damper 32, the second air mix damper 34 is formed by a butterfly-shaped structure, and is rotated by a driving effect of an actuator (not shown) so as to adjust the blowing amount (blowing ratio) of the cold air in the cold air communicating path 30.

The vent damper 36 has a cantilevered construction in which the vent damper 36 is supported by a shaft portion 46 between the vent air-outlet 20 and the defrost air-outlet 22. The vent damper 36 includes a door portion 48 that causes the either one of the vent air-outlet 20 and the defrost air-outlet 22 to be blocked and the other one to be opened by rotating the door portion 48 under driving effect of an actuator (driving source) with the above shaft portion 46 as a fulcrum.

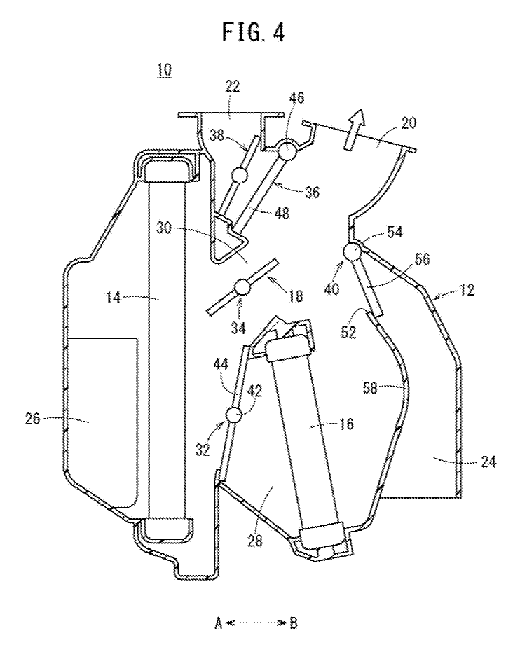

The heat damper 40 has the same cantilever construction as the vent damper 36, and is configured in such a manner that the heat damper 40 is axially supported by a shaft portion 54 at a position adjacent to a heat opening portion (a first opening, a heat opening) 52. The heat damper 40 includes a door portion 56 that is provided on the lower side, and is driven by the same actuator as the vent damper 36. In addition, the heat damper 40 causes the heat opening portion 52 to be in an opened state by rotating the door portion 56 towards the side of the heat communicating path 24 under the driving effect of the actuator (see FIG. 1), and, on the contrary, causes the above heat opening portion 52 to be in a blocked state by rotating the door portion 56 to abut against a wall portion 58 (see FIG. 4).

The air conditioning apparatus for a vehicle 10 according to a preferred embodiment of the present invention generally has the configuration as described above, and its operations and effects will be described next.

To begin with, a case in which a bi-level mode (a first mode) is selected in which air is blown to the vicinity of the face and the foot of a passenger in a compartment of a vehicle will be described with reference to FIG. 1.

First, when the air conditioning apparatus for a vehicle 10 is activated, the air sucked by the blower (not shown) is supplied to the supply communicating path 26 of the air conditioning case 12 and is cooled by passing through the evaporator 14. In this bi-level mode, under the driving effect of the actuators (not shown), the first air mix damper 32 is rotated by a predetermined angle from a fully closed state such as to become in a state in which the cold air can flow to the side of heating core 16, the second air mix damper 34 is rotated by a predetermined angle such as to become in a fully opened state, and the vent damper 36 is opened to the middle of the fully closed position and the fully opened position. In addition, the defrost air-outlet 22 is blocked by the defrost damper 38, and the heat damper 40 is rotated towards the direction away from the heat opening portion 52 such as to become in a fully opened state.

Thereby, a portion of the cold air cooled by passing through the evaporator 14 is blown from the opened vent air-outlet 20 to a vicinity of a face of a passenger in the compartment by passing through the cold air communicating path 30 so as to bypass the heating core 16. At the same time, the remained cold air is heated and changed to warm air in the warm air communicating path 28 by passing through the heating core 16, and then is blown from the opened heat opening portion 52 to a vicinity of a foot of a passenger in the compartment by passing through the heat communicating path 24.

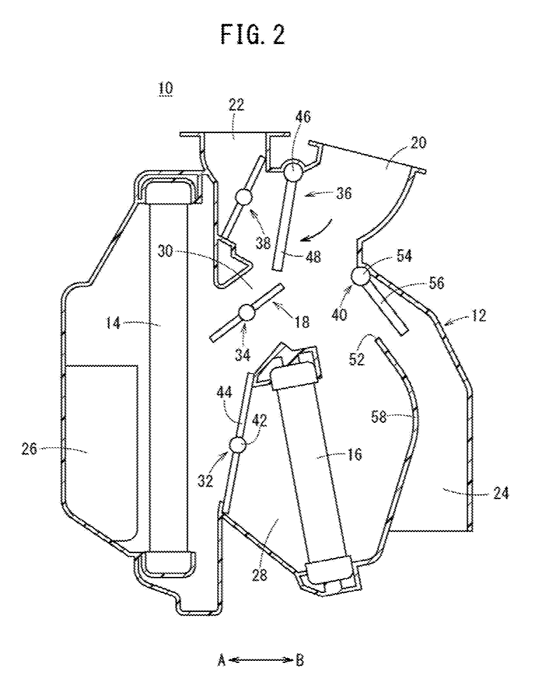

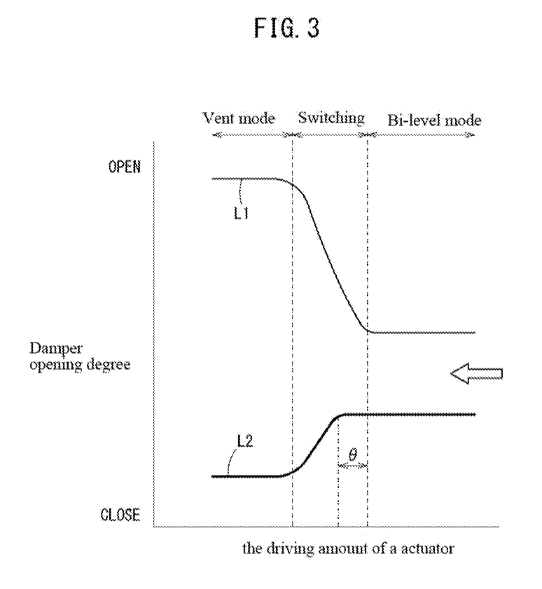

Next, a case in which the mode is switched from the above bi-level mode to a vent mode (a second mode) in which air is blown only to the vicinity of the face of the passenger in the compartment will be described with reference to FIGS. 2 and 3. It should be noted that FIG. 3 is a characteristic graph showing a relationship between the driving amount (operation angle) of the actuator and the vent and heat dampers 36 and 40. Here, the characteristic curve L1 (thin solid line) shows the opening degree of the vent damper 36, and the characteristic curve L2 (thick solid line) shows the opening degree of the heat damper 40.

First, the door portion 48 starts to rotate towards the side of the defrost air-outlet 22 with the shaft portion 46 as a fulcrum by causing the vent damper 36 to start to open towards the fully opened state under the driving effect of the actuator. At this time, the heat damper 40 does not start the closing operation and is in the fully opened state.

Then, after the vent damper 36 is rotated by a predetermined angle, the heat damper 40 is caused to start the closing operation with the shaft portion 54 as a fulcrum in such a manner that the door portion 56 approaches the side of the heat opening portion 52. That is, as shown in FIG. 3, with respect to the driving amount of the actuator, the heat damper 40 is caused to start the closing operation later than the opening operation of the vent damper 36 by a predetermined angle θ. Thereby, the total opening area communicating with the outside would not be narrowed due to the operation of the above vent damper by causing the vent damper 36 to start the opening operation firstly. Therefore, the pressure (internal pressure) within the air conditioning case 12 would not rise, and it is possible to suppress the internal pressure from being a resistance when the above vent damper 36 is rotated towards the blowing direction. Then, in the state where the vent damper 36 is opened to a certain degree and the internal pressure is reduced, the heat damper 40 is caused to start the closing operation.

As shown in FIG. 4, the vent damper 36 is further rotated and becomes a fully opened state, and the door portion 56 of the heat damper 40 abuts against the wall portion 58 and becomes the state of blocking the heat opening portion 52, such that the mode is switched to the vent mode in which the cold air flowed through the cold air communicating path 30 is blown from the vent air-outlet 20 only to the vicinity of the face of a passenger in the compartment.

As shown above, in the preferred embodiments, in the air conditioning system for a vehicle 10, when the mode is switched from the bi-level mode in which air is blown to the vicinity of the face and the foot of the passenger to the vent mode in which air is blown only to the vicinity of the face, the vent damper 36 and the heat damper 40 are caused not to operate simultaneously, but the above vent damper 36 is caused to start the opening operation firstly and is operated to a predetermined angle θ with respect to the driving amount of the actuator, and after the vent air-outlet 20 is sufficiently opened, then the above heat damper 40 is caused to start the closing operation. With this, the heat damper 40 is caused to perform the opening operation in a state where the pressure (internal pressure) within the air conditioning case 12 does not rise due to the open of the vent air-outlet 20, such that the operation resistance to the heat damper 40 can be reduced, thereby enabling it to operate smoothly.

Therefore, when switching to the vent mode, since the driving load of the actuator for driving the vent damper 36 is reduced, it can realize the reduction of the driving torque.

Further, the vent damper 36 has a cantilevered construction in which a shaft portion 46 is formed at an end portion of the door portion 48, wherein the above door portion 48 is operated so as to be opposite to the flow direction of the air in the air conditioning case 12 when being driven. The door portion 48 is easily affected by the internal pressure of the air conditioning case 12, but the door portion 48 can be effectively operated smoothly by causing the vent air-outlet 20 to be opened firstly to reduce the internal pressure and guiding most of the above air to the vent air-outlet 20 as described above.

In addition, the vent damper 36 and the heat damper 40 are driven by the same actuator, whereby the driving torque is increased as compared with the case where they are driven by the respective separated actuators. However, the driving torque can be effectively reduced and a small size of the actuator, for example, can be realized, by reducing the internal pressure within the air conditioning case 12 as described above.

In addition, in the air conditioning apparatus for a vehicle 10 according to the preferred embodiments described above, a case where the damper mechanism 18 is operated by an actuator has been described, but the present invention is not limited thereto. For example, the above damper mechanism 18 may be operated by a wire harness connected to an operating rod provided in the compartment.

In addition, the operations of the vent damper 36 and the heat damper 40 in the case of switching from the bi-level mode to the vent mode has been described, but the present invention is not particularly limited thereto. For example, when the mode is switched from the heat defrost mode in which air is blown to the front window of the vehicle and the vicinity of the foot to the defrost mode in which air is blown only to the above front window, the pressure within the air conditioner case 12 is suppressed from rising by opening the defrost damper 38 firstly before closing the heat damper 40. Thereby, the effect of reducing the operation resistance of the damper mechanism 18 is obtained.

In addition, the air conditioning apparatus for a vehicle of the present invention is not limited to the above embodiments, and it is needless to say that various structures can be employed without departing from the scope of the spirit of the present invention.

### REFERENCE NUMERAL LIST

10: air conditioning apparatus for vehicle;

12: air conditioning case;

18: damper mechanism;

20: vent air-outlet;

24: heat communicating path;

28: warm air communicating path;

30: cold air communicating path;

36: vent damper;

40: heat damper;

44, 48, 56: door portion;

52: heat opening portion.

What is claimed is:

1. An air conditioning apparatus for a vehicle, comprising:
a blower;
an air conditioning case having an air flow path through which air from the blower flows formed therein;
a first opening and a second opening that each communicate between an outer side and an inner side of the air conditioning case at a downstream side of the air flow path;
a first door that opens/closes the first opening;
a second door that opens/closes the second opening; and
a driving source that drives at least either one of the first door and the second door, and
said air conditioning apparatus being configured with:
a first mode in which the first door causes the first opening to be opened and the second door causes the second opening to be fully closed or to be opened with a middle opening degree; and
a second mode in which the first door causes the first opening to be closed more than in the first mode and the second door causes the second opening to be opened more than in the first mode,
wherein when a transition is made from the first mode to the second mode, the second door is caused to start opening operation before the first door performs closing operation.

2. The air conditioning apparatus for a vehicle according to claim 1, wherein
the second door is a plate door which is provided with a rotating shaft on a shield plate, and when a transition is made from the first mode to the second mode, the shield plate is moved towards a direction opposite to the direction of the air.

3. The air conditioning apparatus for a vehicle according to claim 1, wherein
the first door and the second door are operated by the same driving source.

4. The air conditioning apparatus for a vehicle according to claim 2, wherein
the first door and the second door are operated by the same driving source.

5. The air conditioning apparatus for a vehicle according to claim 1, wherein
the first opening is a heat opening which is connected to a duct for guiding the air to the vicinity of the foot of a passenger, and the second opening is a vent opening which is connected to a duct for guiding the air to the vicinity of the face of the passenger,
the first mode is a bi-level mode in which the opening degree of each of the first and second doors is caused to be a middle opening degree, and the second mode is a vent mode in which the first door causes the heat opening to be blocked and the second door causes the vent opening to be in a fully opened state.

6. The air conditioning apparatus for a vehicle according to claim 2, wherein
the first opening is a heat opening which is connected to a duct for guiding the air to the vicinity of the foot of a passenger, and the second opening is a vent opening which is connected to a duct for guiding the air to the vicinity of the face of the passenger,
the first mode is a bi-level mode in which the opening degree of each of the first and second doors is caused to be a middle opening degree, and the second mode is a vent mode in which the first door causes the heat opening to be blocked and the second door causes the vent opening to be in a fully opened state.

7. The air conditioning apparatus for a vehicle according to claim 3, wherein
the first opening is a heat opening which is connected to a duct for guiding the air to the vicinity of the foot of a passenger, and the second opening is a vent opening which is connected to a duct for guiding the air to the vicinity of the face of the passenger,
the first mode is a bi-level mode in which the opening degree of each of the first and second doors is caused to be a middle opening degree, and the second mode is a vent mode in which the first door causes the heat opening to be blocked and the second door causes the vent opening to be in a fully opened state.

8. The air conditioning apparatus for a vehicle according to claim 4, wherein
the first opening is a heat opening which is connected to a duct for guiding the air to the vicinity of the foot of a passenger, and the second opening is a vent opening which is connected to a duct for guiding the air to the vicinity of the face of the passenger,
the first mode is a bi-level mode in which the opening degree of each of the first and second doors is caused to be a middle opening degree, and the second mode is a vent mode in which the first door causes the heat opening to be blocked and the second door causes the vent opening to be in a fully opened state.
